(19) United States
(12) Patent Application Publication
(10) Pub. No.: US 2012/0217895 A1
(43) Pub. Date: Aug. 30, 2012

(54) LAMP TUBE DRIVING DEVICE, LAMP TUBE MODULE, AND LAMP TUBE DRIVING SYSTEM

(75) Inventor: JIH-YUAN LEE, Keelung City (TW)

(73) Assignee: TAIWAN SUMIDA ELECTRONICS INCORPORATED, New Taipei City (TW)

(21) Appl. No.: 13/033,832

(22) Filed: Feb. 24, 2011

(51) Int. Cl. H05B 41/16

(52) U.S. Cl. 315/276; 315/246

(57) ABSTRACT

Disclosed is a lamp-tube driving device including a controller, an oscillating circuit, a converter, and a protective circuit. Connection relations there-between include the oscillating circuit coupled to the controller, the converter coupled to the controller and CCFL, and the protective circuit coupled to the CCFL and oscillating circuit. The controller is activated in response to first input voltage, and configured to output a control signal in response to second input voltage. The oscillating circuit is able to adjust oscillating frequency of operation clock for the controller. The converter is controlled with the control signal, and configured to convert third input voltage into an output voltage. This output voltage is for driving the CCFL. The protective circuit disables the oscillating circuit when the CCFL remains at a state such as open circuit or short circuit. A lamp-tube module and a lamp-tube driving system for the lamp-tube driving device are further disclosed.

### BACKGROUND OF THE INVENTION

1. Field of the Invention

The instant disclosure relates to a lamp tube driving device, a lamp tube module, and a lamp tube driving system, more particularly to the driving device, lamp tube module and driving system for a cold cathode fluorescent lamp.

2. Description of Related Art

Reference is made to FIG. 1 that shows a schematic diagram of a traditional illumination lamp equipped with a cold cathode fluorescent lamp (CCFL). This CCFL illumination lamp 4 includes a lamp housing 41 having a volume (not shown in FIG. 1) for containing an AC-to-DC converter 40, a DC-to-AC converter 43, and one or more CCFLs 44.

In the conventional CCFL illumination lamp 4, an electrode tip 440 of the CCFL 44 is connected to an output of the DC-to-AC converter 43. When the AC-to-DC converter 40 is operated with the DC-to-AC converter 43, the DC-to-AC converter 43 is able to output high-voltage alternating current for driving the CCFL 44. In general, the voltage to drive the CCFL 44 is around 500V to 2000V, and that is substantially depending on the size of CCFL 44.

The mentioned tip 440 of the CCFL 44 generates the high voltage since it receives the voltage from the DC-to-AC converter 43. In this case, it is inconvenient and improper for the user fixing the broken CCFL 44 by himself as it remains at an open circuit or a short circuit state since the CCFL 44 is at risk of high voltage. In the meantime, the DC-to-AC converter 43 may continuously impose the high-voltage AC on the broken CCFL 44, and the DC-to-AC converter 43 may also be failed.

### SUMMARY OF THE INVENTION

In view of the mentioned drawback of the conventional art, a lamp tube driving device, a lamp tube module, and a related lamp tube driving system are disclosed. In the invention directed to the device, module and system, the lamp tube driving device can be disabled for self-protection when the CCFL is failed, such as at an open circuit or short circuit state. In the meantime, the lamp tube module of the lamp tube driving system is provided to be safely replaced by the user.

In accordance with one of the embodiments, the lamp tube driving device includes a controller, an oscillating circuit, a converter and a protective circuit. The controller is initiated in response to a first input voltage. The controller then outputs a control signal based on a second input voltage. The oscillating circuit is coupled to the controller, and used for adjust an oscillating frequency of the operation clock for the controller. The converter is coupled to the controller and a CCFL. The converter is controlled by referring to the control signal, and to convert a third input voltage into an output voltage. This output voltage is used to drive the CCFL. The protective circuit is coupled to the CCFL and the oscillating circuit, and used to disable the oscillating circuit when the CCFL is at state of open circuit or short circuit.

In accordance with one further embodiment, the lamp tube module includes the above-mentioned lamp tube driving device, a CCFL, and an insulation unit. The insulation unit covers part of the CCFL and part of the lamp tube driving device.

In accordance with one more embodiment, the lamp tube driving system includes a power transformer and at least one previously-mentioned lamp tube module. The power transformer is coupled to at least one of the lamp tube modules.

In summation, the lamp tube driving device in one embodiment can disable the oscillating circuit by the protective circuit when the CCFL is at open circuit or short circuit state. Therefore, the lamp tube driving device can be protected by its own protective mechanism. In one further embodiment, the lamp tube module with the part of CCFL and the lamp tube driving device covered by the insulation unit provides the users a convenient way to replace the lamp by themselves.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of the conventional CCFL illumination lamp;

FIG. 2 shows a schematic diagram of the CCFL illumination lamp of the embodiment in accordance with the instant disclosure;

FIG. 3 shows a schematic diagram of the lamp tube module in accordance with the instant disclosure;

FIG. 4 depicts the function diagram of the lamp tube driving device in accordance with the instant disclosure; and

FIG. 5 is a diagram describing the detail of the lamp tube driving device of one embodiment in accordance with the present disclosure.

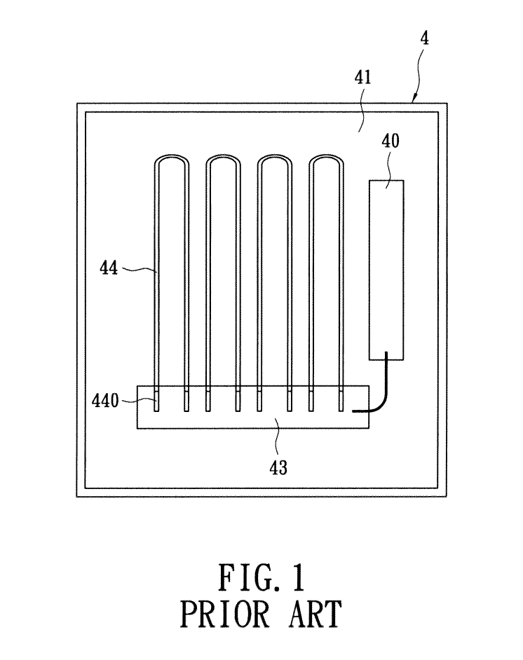

### DETAILED DESCRIPTION OF THE PREFERRED EMBODIMENTS

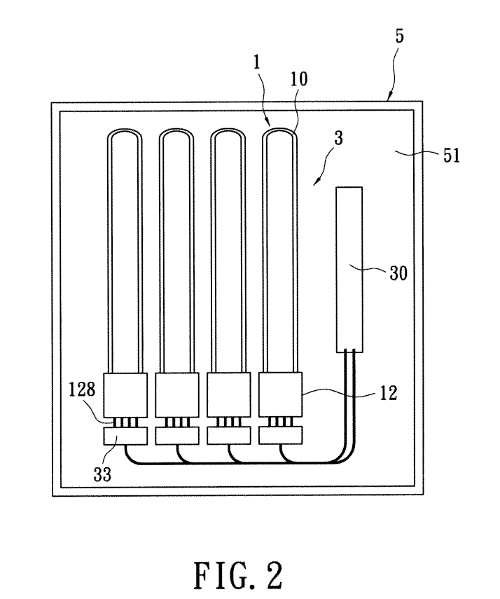

Reference is made to FIG. 2 showing a schematic diagram of a CCFL illumination lamp of the embodiment in accordance with the instant disclosure. The shown CCFL illumination lamp 5 mainly has a lamp tube driving system 3 and a lamp housing 51. The lamp tube driving system 3 includes a power transformer 30 and at least one lamp tube module 1. The power transformer 30 is coupled to the every lamp tube module 1. The power transformer 30 is preferably an AC-to-DC converter used for converting an alternating current into multiple DC input voltages. The DC input voltages are used to supply power to the every lamp tube module 1.

The lamp tube driving system 3 may be disposed within a lamp housing 51. In other words, a volume for placing a lamp tube driving system 3 is disposed within the lamp housing 51. The lamp housing 51 is designed as a rectangular cube. Therefore, the CCFL illumination lamp 5 can be disposed, but not limited to, inside the light-steel frame under the ceiling. In other cases, the appearance of lamp housing 4 may be variously designed, such as the housing of ceiling light, the casing of advertisement signboard, or the lampshade of desk lamp.

Further in FIG. 2, the lamp tube driving system 3 uses at least one connector 33 to bridge the power transformer 30 and every lamp tube module 1. In other words, the ends of the connectors 33 are commonly connected to the output of the power transformer 30. The other ends of the connectors 33 are the power plugs one-by-one coupled to the corresponding lamp tube modules 1. In the current example, one of the connectors 33 is electrically connected to its corresponding lamp tube module 1, especially via a plug-in means. That is, the power plug of this connector 33 is provided to the user plugging in a power-supply input 128, or removing the power-supply input 128 from the lamp tube module 1. Furthermore, the sizes for both the power plug of the connector 33 and the power-supply input 128 of the lamp tube module 1 are correspondingly configurable as required. Thus a Poka-yoke feature is introduced into the connection between the power plug of connector 33 and the input 128 of the lamp tube module 1.

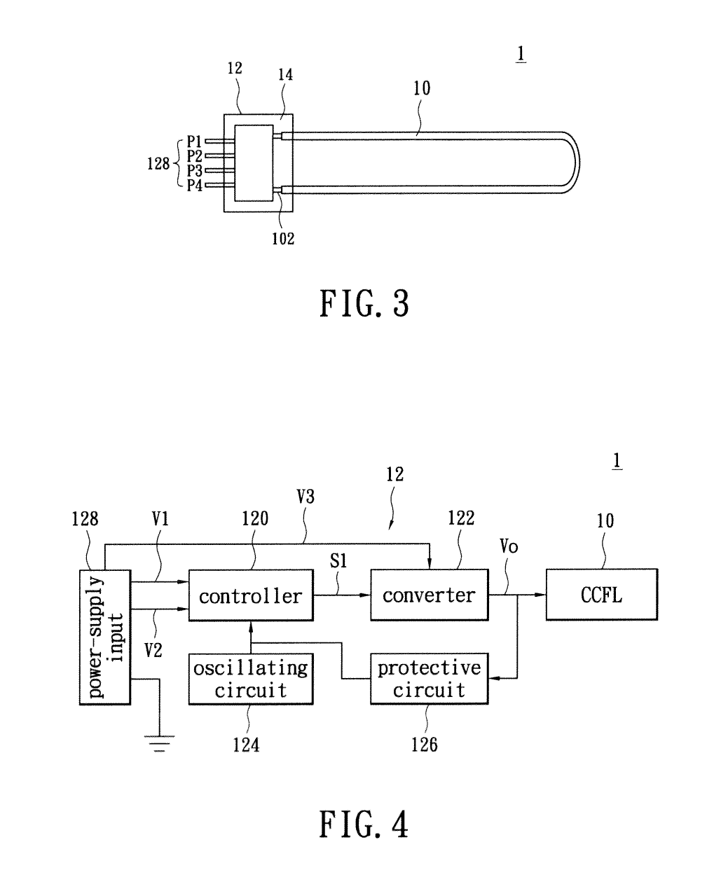

Reference is made to FIG. 3, in view of FIG. 2, where FIG. 3 depicts a schematic diagram of the lamp tube module of one embodiment in accordance with the disclosure. The shown lamp tube module 1 includes a CCFL 10, a lamp tube driving device 12 and an insulation unit 14. In an exemplary example, the CCFL 10 may be implemented as a U-type CCFL, but it may also be other types of CCFLs. Further, an output of the lamp tube driving device 12 is coupled to the electrode tip 102 of the CCFL 10. The power-supply input 128 of the lamp tube driving device 12 includes four pins, such as the shown pins P1, P2, P3, and P4. This power-supply input 128 may also be the output of the lamp tube module 1.

The pins P1, P2, P3, and P4 may receive multiple DC input voltages from the power transformer 30. For example, the pin P1 receives a first input voltage V1, the pin P2 receives a second input voltage V2, the pin P3 receives a third input voltage V3, and the pin P4 is for a ground. That is, the configurations of the four pins P1, P2, P3, and P4 may not be used to limit the application of the disclosure. However, the pins P1, P2, P3, and P4 may be variously defined according to the specifications of the CCFL 10.

More, the insulation unit 14 is used to cover part of the lamp tube driving device 12 and part of the CCFL 10. The part of the power-supply input 128 of the lamp tube driving device 12 is exposed out of the insulation unit 14. The exposed portion is used to connect with a connector 33. The power-supply input 128 is therefore electrically connected to the power transformer 30 via the connector 33. The power transformer 30 then outputs multiple input voltages V1 to V3 to the lamp tube driving device 12. The lamp tube driving device 12 is to drive the CCFL 10 in response to these input voltages V1 to V3. Furthermore, the mentioned insulation unit 14 may be a plastic casing, and inside the casing a cooling gel is injected. This cooling gel may facilitate cooling down the lamp tube driving device 12.

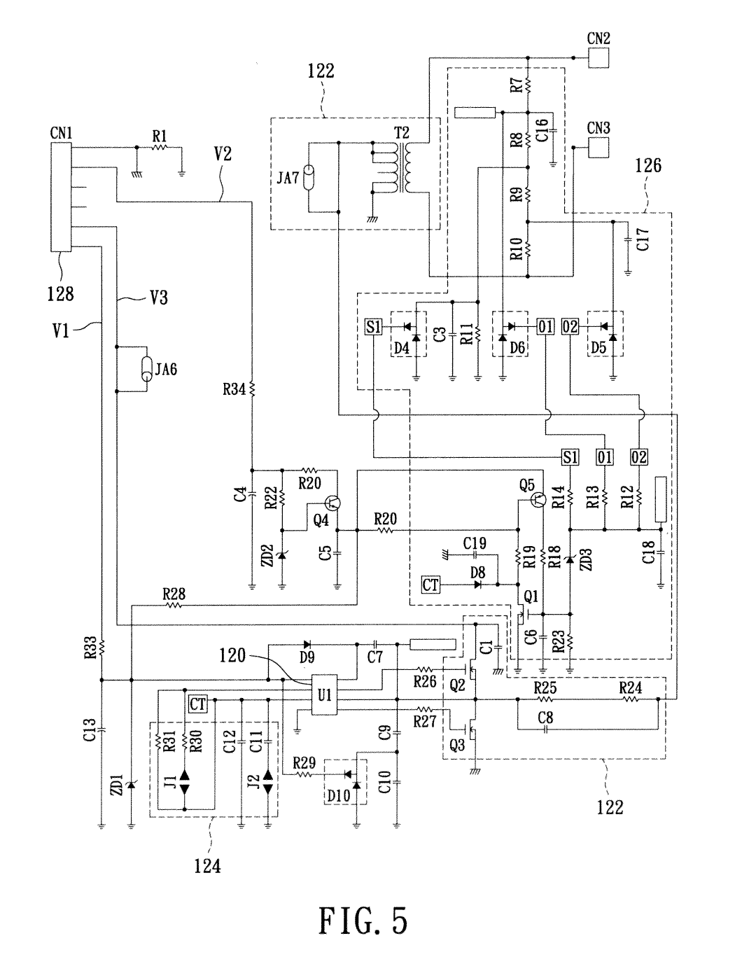

References are made to FIG. 4 and FIG. 5, and in view of FIG. 2. The function blocks of the lamp tube driving device are shown in FIG. 4. FIG. 5 shows the detail of the circuit of the lamp tube driving device in one embodiment. This lamp tube driving device 12 is particularly used to drive the CCFL 10. The device 12 at least includes a controller 120 (U1), an oscillating circuit 124, a converter 122, a protective circuit 126, and a power-supply input 128. The controller 120 is especially coupled to the power-supply input 128. The oscillating circuit 124 is coupled to the controller 120. The oscillating circuit 124 is coupled to the controller 120. The converter 122 is coupled to interconnect the controller 120 and the CCFL 10. The protective circuit 126 is coupled to the CCFL 10 and the oscillating circuit 124.

Next, in FIG. 5, the oscillating circuit 124 is comprised of resistors R30 and R31, capacitors C11 and C12, and jump plugs J1 and J2. The converter 122 is comprised of switches Q2 and Q3, capacitors C1 and C8, and resistors R24 and R25. The protective circuit 126 is comprised of switches Q1 and Q5, resistors R7 to R14, R18 to R19, capacitors C16 to C19, C3, C6 and diodes D4 to D6, D8 and ZD3.

The described four pins P1, P2, P3, and P4 of the power-supply input 128 separately receive the first input voltage V1, the second input voltage V2, and the third input voltage V3 from the power transformer 30, and one pin for the ground. In response to the first input voltage V1, the controller 120 is initiated. The controller 120 then outputs a control signal S1 in response to the second input voltage V2. The first input voltage V1 is particularly an initiating voltage for the controller 120. This initiating voltage is around 390V DC. The second input voltage V2 is an operation voltage for the controller 120, and is around 18V DC.

The oscillating circuit 124 is used to modulate an oscillating frequency of operation clock for the controller 120. The oscillating circuit 124 is exemplarily an RC circuit. In which, the related resistance and capacitance are configured to provide various oscillating frequencies of the operation clock for the controller 120. Further, the converter 122 receives the third input voltage V3 from the power-supply input 128. Then the converter 122 is controlled in response to the control signal S1 generated from the controller 120, and converts the third input voltage V3 into an output voltage Vo. This output voltage Vo is to drive the CCFL 10.

The control signal S1 sent from the controller 120 is preferably a PWM (pulse-width modulation) signal or a PFM (pulse-frequency modulation) signal. The PWM signal or PFM signal is principally used for controlling the converter 122 to convert the third input voltage V3 into the output voltage Vo. This output voltage Vo is used to drive the CCFL 10. The third input voltage V3 is around 390V DC, which is used as a main voltage for the converter 122. The converter 122 is preferably a DC-to-AC converter, which is alternatively an inverter. The output voltage Vo of the converter 122 is, but not limited to, around 500V to 2000V AC. The output voltage Vo may be configured in accordance with the specification of CCFL 10.

Functionally, the protective circuit 126 may disable the oscillating circuit 124 when the CCFL 10 remains open circuit or short circuit state. In other words, the protective circuit 126 is able to detect the operation state of the CCFL 10 from its electrode tip 102. When the CCFL 10 is at open circuit or short circuit state, the oscillating circuit 124 is configured to connect a ground. It is to protect the controller 120 as the oscillating circuit 124 stops the controller 120.

In the state of the CCFL 10 remaining open circuit or short circuit, the protective circuit 126 allows a floating connection interconnecting the oscillating circuit 124 and the controller 120. Meanwhile, the oscillating circuit 124 may also stop the controller 120 for conducting protection.

In summation of the above description, the lamp tube driving device in accordance with the invention allows a protective circuit to disable the oscillating circuit when the CCFL remains open circuit or short circuit state. Therefore, this lamp tube driving device may be protected by itself. In one aspect of the invention, it is convenient and safely to replace the lamp tube since it is provided that the insulation unit covers part of the lamp tube module having the CCFL and lamp tube driving device.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A lamp tube driving device for driving a CCFL, comprising:
a controller, being initiated in response to a first input voltage, and outputting a control signal in response to a second input voltage;
an oscillating circuit, coupled to the controller, wherein the oscillating circuit is used to adjust an oscillating frequency of an operation clock of the controller;
a converter, coupled to the controller and the CCFL, wherein the converter is controlled by referring to the control signal, and used to convert a third input voltage into an output voltage for driving the CCFL; and
a protective circuit, coupled to the CCFL and the oscillating circuit, wherein the protective circuit disables the oscillating circuit when the CCFL remains at an open circuit or a short circuit state.

2. The lamp tube driving device of claim 1, further comprising a power-supply input, which is coupled to the controller and the converter.

3. The lamp tube driving device of claim 2, wherein the power-supply input includes four pins.

4. The lamp tube driving device of claim 1, wherein the converter is a DC-to-AC converter.

5. The lamp tube driving device of claim 1, wherein the oscillating circuit is an RC circuit.

6. A lamp tube module, comprising:
a CCFL;
a lamp tube driving device, comprising:
a controller, being initiated in response to a first input voltage, and outputting a control signal in response to a second input voltage;
an oscillating circuit, coupled to the controller, wherein the oscillating circuit is used to adjust an oscillating frequency of an operation clock of the controller;
a converter, coupled to the controller and the CCFL, wherein the converter is controlled by referring to the control signal, and used to convert a third input voltage into an output voltage for driving the CCFL;
a protective circuit, coupled to the CCFL and the oscillating circuit, wherein the protective circuit disables the oscillating circuit when the CCFL remains at an open circuit or a short circuit; and
an insulation unit, covering part of the CCFL and part of the lamp tube driving device.

7. The lamp tube module of claim 6, wherein the lamp tube driving device further comprises a power-supply input, which is coupled to the controller and the converter, and the insulation unit covers part of the power-supply input.

8. A lamp tube driving system, comprising:
a power transformer, transforming an alternating current into a first input voltage, a second input voltage, and a third input voltage;
at least one CCFL;
at least one lamp tube driving device, coupled to the power transformer and the corresponding CCFL, wherein the lamp tube driving device comprises:
a controller, being initiated in response to the first input voltage, and outputting a control signal in response to the second input voltage;
an oscillating circuit, coupled to the controller, wherein the oscillating circuit is used to adjust an oscillating frequency of an operation clock of the controller;
a converter, coupled to the controller and the CCFL, wherein the converter is controlled by referring to the control signal, and used to convert third input voltage into an output voltage for driving CCFL;
a protective circuit, coupled to the CCFL and the oscillating circuit, wherein the protective circuit disables the oscillating circuit when the CCFL remains at an open circuit or a short circuit state; and
an insulation unit, covering part of the CCFL and part of the lamp tube driving device.

9. The lamp tube driving system of claim 8, wherein the lamp tube driving device further comprises a power-supply input, which is coupled to the controller and the converter, and the insulation unit covers part of the power-supply input.

10. The lamp tube driving system of claim 8, wherein the power transformer is an AC-to-DC converter.

11. The lamp tube driving system of claim 8, further comprising at least one connector, which couples to the power transformer and the corresponding lamp tube driving device.
